(19) United States
(12) Patent Application Publication
(10) Pub. No.: US 2007/0081421 A1
(43) Pub. Date: Apr. 12, 2007

(54) Feed mixing tank

(76) Inventors: Yean-Der Kuan, Taipei (TW); Chia-Hao Chang, Taipei (TW); Jing-Yi Chang, Taipei (TW)

Correspondence Address: G. LINK Co.,LTD, 3550 Bell Road, MINOOKA, IL, 60447, US

(21) Appl. No.: 11/245,002

(22) Filed: Oct. 7, 2005

(51) Int. Cl. B01F 5/00

(52) U.S. Cl. 366/341

(57) ABSTRACT

The present invention is a feed mixing tank. The regulating portion is a topology structure and has at least one collecting part, at least one shunt part and at least one flow channel, wherein the collecting part, the shunt part and the flow channel are connected to each other to mix and separate fuel therein. The pour-in portion pours outside fuel in the feed mixing tank and connects to the regulating portion. The output portion outputs the fuel passing through the regulating portion and connects to the regulating portion.

### FIELD OF THE INVENTION

The present invention is a feed mixing tank for a fuel cell device, in particular a regulating portion being designed to equalize fuel concentration for the fuel averagely distributed to a plurality of fuel cell devices.

### BACKGROUND OF THE INVENTION

Please refer to FIG. 1, which is a sketch of a fuel-feed tank of a fuel cell device in the prior arts. The fuel-feed tank 3 has a plurality of channels 31 shaped as strips and parallel each other to be flow paths of fuel, thus the fuel can be guided to each fuel cell devices. An end of the fuel-feed tank 3 has a plurality of inlets 33 for inputting outside fuel, and the input fuel goes to the channels 31 immediately. Another end of the fuel-feed tank 3 has a plurality of outlets 35 for the fuel that passes through the channels 31 going to a plurality of fuel cell devices. The channels 31 are separated and parallel each other in an S shape for the best mixture of the fuel from different inlets 33. Due to the structure, the mixture of the fuel-feed tank 3 is not good enough, and the fuel cannot be averagely distributed to each of the fuel cell devices by reason of the pressure drop or the pressure deficit of the outlets 35.

The inventor of the present invention has done his best to develop a feed mixing tank applied on a fuel cell device for figuring out the shortcomings in the prior arts.

### SUMMARY OF THE INVENTION

The primary objective of the present invention is to provide a feed mixing tank to gain fuel with uniform concentration for the fuel being averagely distributed to each fuel cell device.

The secondary objective of the present invention is to provide a feed mixing tank to gain fuel with uniform concentration for each fuel cell device being supplied by the fuel with a certain amount of flow rate, flow speed and concentration.

To approach the above objectives, the present invention provides the feed mixing tank comprising: a regulating portion being a topology structure and having at least one collecting part, at least one shunt part and at least one flow channel, wherein the collecting part, the shunt part and the flow channel are connected to each other to mix and separate some fuel therein; a pour-in portion for pouring outside fuel in the feed mixing tank, wherein the pour-in portion and the regulating portion are connected to each other; and an output portion for outputting the fuel passing through the regulating portion, wherein there is the output portion and the regulating portion.

### BRIEF DESCRIPTION OF THE DRAWINGS

The foregoing aspects, as well as many of the attendant advantages and features of this invention will become more apparent with reference to the following detailed description, when taken in conjunction with the accompanying drawings, wherein:

FIG. 1 is a sketch of a fuel-feed tank of a fuel cell device in the prior arts;

FIG. 2 is a sketch of a structure of a feed mixing tank of the present invention;

FIG. 3 is a sketch of a preferred embodiment of the present invention;

FIG. 4 is a sketch of a structure of a collecting part of the regulating portion of the present invention; and

FIG. 5 is a sketch of a structure of a shunt part of the regulating portion of the present invention.

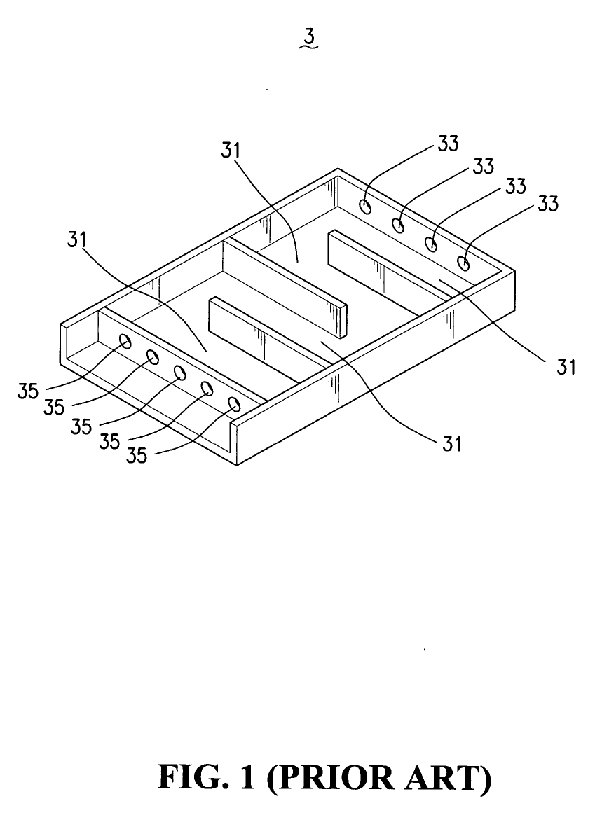

### DETAILED DESCRIPTION OF THE INVENTION

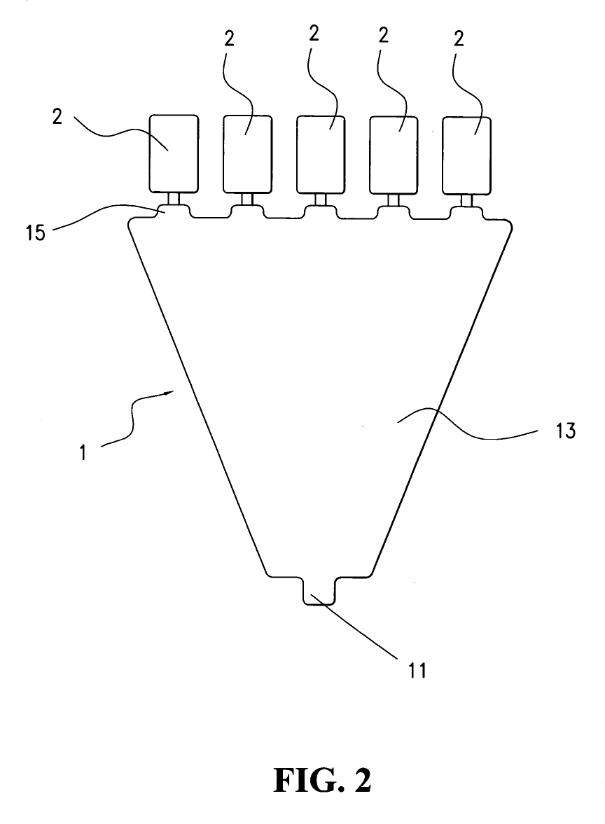

Please refer to FIG. 2, which is a sketch of a structure of a feed mixing tank 1 of the present invention. The feed mixing tank 1 is capable of offering fuel for a plurality of fuel cell devices. The main function of the feed mixing tank 1 is to averagely mix fuels with different kinds of concentrations from a pour-in portion 11. The fuel can continuously be adjusted by a regulating portion 13 for a uniform flow rate and a uniform flow speed thereof. Finally an output portion 15 averagely distributes the fuel to each of the fuel cell devices 2.

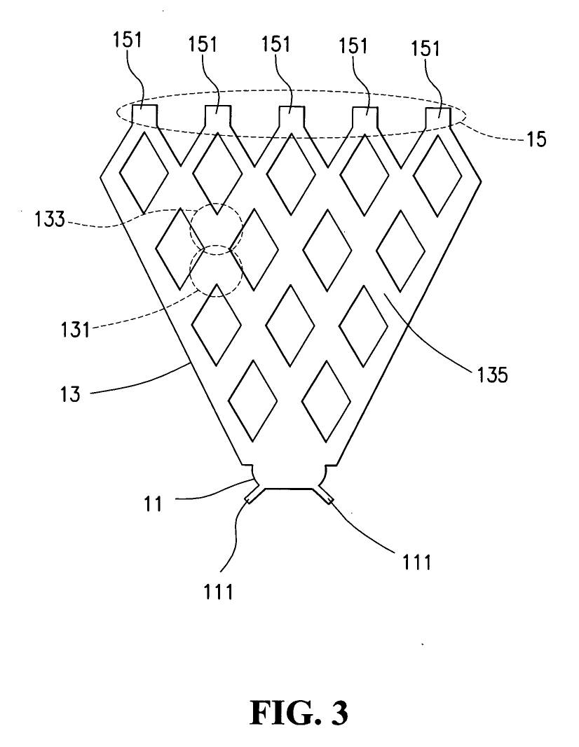

Please refer to FIG. 3, which is a sketch of a preferred embodiment of the present invention. The feed mixing tank 1 in FIG. 3 is a topology structure and includes the regulating portion 13, the pour-in portion 11 and the output portion 15. The detailed description is as follows: each of the fuel cell devices 2 is connected to the output portion 15, and each fuel cell device 2 is capable of gaining the fuel with a uniform flow rate and a uniform flow speed because of the feed mixing tank 1. On the other hand, fuels with different kinds of concentrations can be entered by means of the pour-in portion 11, and the fuels are mixed in the pour-in portion 11 for a uniform concentration. The regulating portion 13 is separately connected to the pour-in portion 11 and the output portion 15. The regulating portion 13 consists of a plurality of collecting parts 131, a plurality of shunt parts 133 and a plurality of flow channels 135, wherein the collecting parts 131, the shunt parts 133 and the flow channels 135 are connected each other. The fuel in the regulating portion 13 is guided by the flow channels 135 and passes through the collecting parts 131 and the shunt parts 133 to the output portion 15. Due to several times of mixture and separation of the fuel in the regulating portion 13, a uniform flow rate and a uniform flow speed are gradually approached.

The pour-in portion 11 includes at least one inlet 111 for pouring outside fuel. Fuels with different kinds of concentrations can be entered by means of the different inlets 111, and the fuels are mixed in the pour-in portion 11. The output portion 15 includes at least one outlet 151 for outputting the mixed fuel to the fuel cell devices 2.

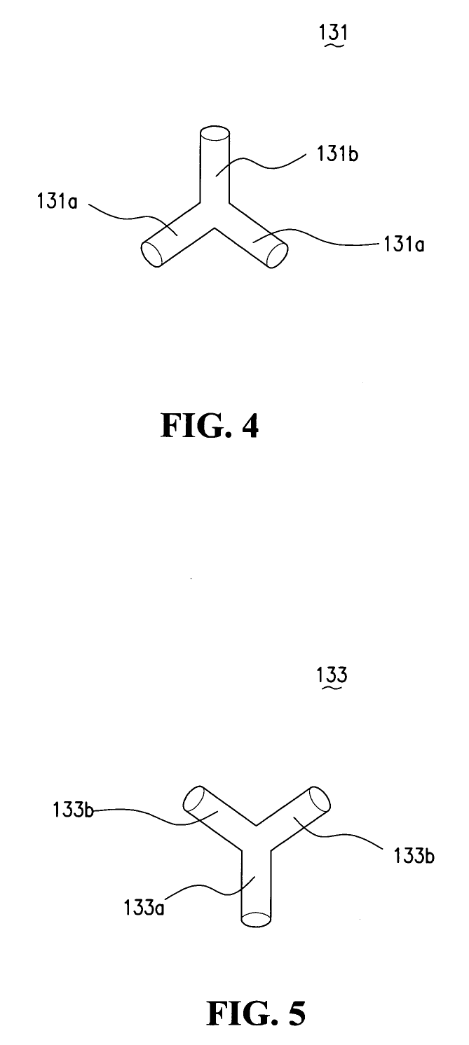

Please refer to FIG. 4, which is a sketch of a structure of a collecting part of the regulating portion of the present invention. A collecting part 131 includes at least two collecting entrances 131a and at least one collecting exit 131b. In such layout, the structure of the collecting part 131 is in a reverse Y shape. Please refer to FIG. 5, which is a sketch of a structure of a shunt part of the regulating portion of the present invention. The shunt part 133 includes at least one shunt entrance 133a and at least two shunt exits 133b. In such layout, the structure of the shunt part 133 is in a Y shape. The collecting part 131 and the shunt part 133 are adjacent and connected to each other so that the collecting exit 131b of the collecting part 131 and the shunt entrance 133a of the shunt part 133 are jointly applied.

Further, the collecting exits 13 1b are symmetrical axes to the collecting entrances 13 1a as far as possible for being a symmetrical structure of the collecting portion 131. The shunt entrances 133a are symmetrical axes to the shunt exits 133b as far as possible for being a symmetrical structure of the shunt portion 133. Due to the symmetrical structure, the fuel has a uniform flow rate and a uniform flow speed after passing through several steps of the collecting portions 131 and the shunt portions 133 to the output portion 15. Therefore each fuel cell device 2 is able to have a stable feature.

The feed mixing tank 1 can be made by way of mold-injecting or die cast, of which the material can be plastic, metal, etc.

The present invention has the following advantages:

1. The present invention can offer fuel with a uniform flow rate, a uniform flow speed and a uniform concentration to each fuel cell device without any additional power, that is, the present invention is suitable for business applications;

2. The structure of the present invention is easily constructed at low cost; and

3. The present invention can be connected to several fuel cell devices simultaneously and promote the poured fuel.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A feed mixing tank comprising:
a regulating portion being a topology structure and having at least one collecting part, at least one shunt part and at least one flow channel, wherein the collecting part, the shunt part and the flow channel are connected to each other to mix and separate fuel therein;
a pour-in portion for pouring outside fuel in the feed mixing tank, wherein the pour-in portion and the regulating portion are connected to each other; and
an output portion for outputting the fuel passing through the regulating portion, wherein there is the output portion and the regulating portion.

2. The feed mixing tank according to claim 1, wherein the collecting part includes at least two collecting entrances and at least one collecting exit, wherein the fuel flows from the collecting entrances to the collecting exit.

3. The feed mixing tank according to claim 1, wherein the shunt part includes at least one shunt entrance and at least two shunt exits, wherein the fuel flows from the shunt entrance to the shunt exits.

4. The feed mixing tank according to claim 2, wherein the collecting exit is a symmetrical axis to the collecting entrance to be a symmetrical structure.

5. The feed mixing tank according to claim 3, wherein the shunt entrance is a symmetrical axis to the shunt exit to be a symmetrical structure.

6. The feed mixing tank according to claim 1, wherein the pour-in portion includes at least one inlet.

7. The feed mixing tank according to claim 1, wherein the output portion includes at least one outlet.

8. The feed mixing tank according to claim 1, wherein the fuel is applied to an anode of a fuel cell device.

9. The feed mixing tank according to claim 1, wherein the fuel is applied to a cathode of a fuel cell device.

10. The feed mixing tank according to claim 1, wherein the fuel is a methanol solution.
